(19) United States
(12) Patent Application Publication
(10) Pub. No.: US 2014/0213214 A1
(43) Pub. Date: Jul. 31, 2014

(54) EMERGENCY NUMBER CALLING WITH PERSONAL COMMUNICATIONS DEVICES

(71) Applicant: Robert S. Reis, Palo Alto, CA (US)

(72) Inventor: Robert S. Reis, Palo Alto, CA (US)

(21) Appl. No.: 14/166,276

(22) Filed: Jan. 28, 2014

Related U.S. Application Data
(60) Provisional application No. 61/758,049, filed on Jan. 29, 2013.

(51) Int. Cl. H04W 4/22

(52) U.S. Cl. CPC H04W 4/22
USPC 455/404.2

(57) ABSTRACT

A personal communications device for communications using a satellite including emergency calls using a satellite in a satellite communications system where the satellite communications system processes emergency calls. The device includes a power unit for powering the personal communications device, a transceiver unit for communicating with the satellite and a control unit for controlling the personal communications device. The control unit includes an emergency call processor for controlling emergency calls with a satellite and includes a location processor for determining the location of the personal communications device whereby an emergency call transmitted to a satellite includes the location of the personal communications device. A user interface provides for emergency call communication with a caller.

This invention relates to mobile personal communications devices which communicate reliably from most all locations of the world and more specifically relates to mobile personal communications devices for making emergency calls.

Mobile personal communications devices transmit and receive telephone calls and other communications using radio frequency (RF) signal channels that cover both small and large geographic areas. Such devices are transported freely and are not required to stay in fixed locations. Some mobile personal communications devices support a wide variety of services and content such as voice, text messaging, multimedia, e-mail, maps, internet and numerous other and related content and applications. Personal communications devices are often used for storing and retrieving contacts, calendars, music, photographs, records and other information.

The demand and need for personal communications devices is expanding at a rapid pace. There are many billions of personal communications devices in use around the world. There is an increasing need for devices that provide reliable one-way and two-way communications, particularly for emergency calls, virtually anywhere in the world even when any particular one or more types of communications channels are not available. Communications services primarily have been provided in channels using wired connections in the Public Switched Telephone Network (PSTN), using wireless connections in cellular networks, using wireless connections in satellite networks. The communications channels include voice and data. Some data channels carry voice using protocols such as VoIP (Voice over Internet Protocol).

Public telephone networks in many countries have a single emergency number for emergency calls. The emergency number differs from country to country. For example, in European countries, the emergency number “112” is used and in North American countries, the emergency number “911” is used.

In North America, the Enhanced 911 service automatically associates a physical address with the caller's telephone number and routes the call to the most appropriate Public Safety Answering Point (PSAP) for that physical address.

There are approximately 6,000 Public Service Access Points (PSAPS) in the U.S. Each PSAP is the communications node to which priority and emergency calls are sent for calls originating in the vicinity of the PSAP location. The PSAP is an operator-managed facility which communicates with callers requesting emergency services. The PSAP operator coordinates the proper emergency service responses via a first responder network.

At the Public Safety Answering Point (PSAP), a dispatcher receives a call from an emergency caller and has Caller Location Information (CLI) available for that caller's location. Typically, the Caller Location Information is integrated into an emergency computer-assisted dispatch (CAD) system which provides the dispatcher with an on-screen street map that highlights the caller's physical location and the nearest available emergency responders. The Caller Location Information for land line calls is a physical address and for wireless calls is a set of coordinates for the caller or the physical address of the cellular tower from which the wireless call originated.

The PSAPS are functional when the location of the caller requesting emergency service is known. Generally, a caller's location is known when the caller is using a PSTN landline communications and/or cellular communications. However, there are many times when a caller in trouble and needing emergency services does not have reliable landline communications and/or reliable cellular communications available. Examples when reliable landline communications and/or cellular communications are not available include callers inside buildings, callers on roads or at other locations not covered by cellular service; at other locations not covered by the caller's particular provider of cellular service; and callers participating in recreational activities including hiking, fishing, skiing, hunting, and boating at remote locations without any adequate service. Although there is frequently a need for personal communications devices to request emergency services through access to a PSAP, many times such access is not available.

Emergency calls from personal communications devices using data networks, in general, are different from emergency calls using PSTN landline communications and emergency calls using cellular communications. Data networks generally do not have location information for callers. There is no relationship between the network addresses used by callers and physical locations of the callers. For data networks using the Internet Protocol (IP), the IP address cannot be used to determine where an emergency call is coming from and hence where emergency services are required for an emergency caller. Further, there is no way to identify from an IP address which emergency service providers should be contacted or which PSAP should process the emergency call. VoIP Enhanced 911 service attempts to overcome the limitations of data systems and enable VoIP providers to support emergency call services. In the VoIP E911 system, a VoIP service provider maintains a data base to associate a physical address with a subscriber's telephone number. When available, this service is not mandatory for customers, may require fees to be paid by customers and permits customers to opt-out. Further, the customer has the obligation of keeping the customer address information up to date and accurate in the provider's data base. Since portable computers and other portable devices using VoIP communications may be transported to widely separated physical addresses, the customer address information in the provider's VoIP data base is likely to be inaccurate and unreliable in many instances.

Mobile Satellite Service (MSS) carriers handle 911 emergency calls using call centers. Satellite phone emergency calls from a caller using a ground transmitter, such as are available from a personal communications device, are up-transmitted to a satellite and are down-transmitted to a satellite call center. The satellite call center forwards the emergency calls to an appropriate Public Safety Answering Point (PSAP). Such operation requires that the call center knows the location of the emergency caller.

Processing emergency calls across a constellation of satellites requires that the satellite emergency call service be international in operation and operate with the emergency call requirements of many different countries and regions. The emergency call numbers (such as 911, 112 and so on) may be numerous, the languages (English, Chinese and so on) may be numerous and many other variables must be considered. Since MSS carriers are interconnected to only a small number of terrestrial points (gateway ground stations), it is difficult for the satellite emergency call services to interface with the existing emergency call Public Service Access Points (PSAPS). The PSAPS were originally designed for land line and cellular communications systems and do not function as well with other systems.

Satellite network channels provide alternative communications to cellular, PSTN and other terrestrial channels. Various satellites in constellations work together to provide coordinated ground coverage for wireless communications. Generally, satellite constellations are either Low Earth Orbiting satellites (LEDs) or geostationary satellites (GEOs).

Low Earth Orbiting satellites (LEDs) are often deployed with a substantial number of satellites in the constellation because the coverage area provided by a single LEO satellite is only a small area on the ground. The area on the ground covered by a single LEO satellite moves as the LEO satellite travels at a high angular velocity. A high angular velocity is needed in order to maintain the LEO satellite in orbit. Many LEO satellites are needed to maintain continuous coverage over regions on the ground. Globalstar and Iridium are companies that use LEO satellites.

Geostationary satellites (GEOs) are generally deployed with a lower number of satellites than LEO satellites since a single GEO satellite, moving at the same angular velocity as the rotation of the Earth's surface, provides permanent coverage over a large region on earth.

In general, mobile satellite personal communications devices require a line-of-sight from the mobile device to the satellite. For good service, at least an 80% view of the sky by the personal communications devices is preferable. Typically, the up-link and down-link communications frequencies to/from the satellites are in the VHF/UHF and/or microwave range. At these frequencies, many objects on land become obstructions to the communications. Objects such as large boulders, earthen walls, mountains, trees, tunnels, vehicles and buildings or the like make satellite communications less reliable. Such obstructions can block signals between satellites and personal communications devices. The more the view of the sky is blocked, the more there will be periods of no service and dropped calls. The success in making calls from and to personal communications devices depends upon where the satellites are positioned relative to the personal communications device at the moment a personal communications device is in use.

Because caller location plays a central role in routing emergency calls, location services for identifying caller locations are critical. The determination of caller location varies as a function of the type of telephone service being provided. Because different types of telephone services for personal communications devices are unavailable or become unavailable from time to time, the location services associated with any particular one of the telephone services similarly may be unavailable from time to time. For example, during a hurricane, earthquake or other disaster, cellular communication service is often lost to many callers due to base station and other failures. When the cellular system is down, emergency calls from cell phones (personal communications devices) cannot be made and the location information that would have been available from the cellular communication service provider is not available to the cell phone.

In normal non-emergency operation, personal communications devices such as smart phones provide location-based services such as Maps, Camera and Safari applications from Apple and in similar applications from other vendors. These location-based services use location information from cellular, Wi-Fi, and Global Positioning System (GPS) networks to determine the locations of the personal communications devices running the location-based applications. These applications, however, do not provide emergency calls or provide for delivery of emergency services.

In consideration of the above background, there is a need for improved personal communications devices that can communicate emergency calls using satellites from most all locations of the world even when other communications channels fail or are otherwise not available.

### SUMMARY

The present invention is a personal communications device for communications including emergency calls using a satellite in a satellite communications system where the satellite communications system processes emergency calls. The device includes a power unit for powering the personal communications device, a transceiver unit for communicating with the satellite and a control unit for controlling the personal communications device. The control unit includes an emergency call processor for controlling emergency calls with a satellite and includes a location processor for determining the location of the personal communications device whereby an emergency call transmitted to a satellite includes the location of the personal communications device. A user interface provides for emergency call communication with a caller.

In one embodiment of the personal communications device, the emergency call processor generates the emergency call as text code and where in the embodiment the text code is translated to TTY code.

In one embodiment of the personal communications device, the TTY code results from the conversion of text to baudot where baudot is the encoding of the call into tones for transmission over a voice channel.

In one embodiment of the personal communications device, the location processor selects the device location from one or more of GPS, Wi-Fi and Cellular location algorithms.

In one embodiment of the personal communications device, a current location register stores the most current device location determined by a location module executing a location algorithm.

In one embodiment, the personal communications device includes a cross-router for selecting the communications services to be used by the device.

In one embodiment, an emergency call system is provided for processing emergency calls from personal communications devices including one or more satellites in a satellite communications system for processing emergency calls with one or more personal communications devices. Each of the personal communications devices includes a power unit for powering the personal communications device, a transceiver unit for communicating with the satellite, a control unit for controlling the personal communications device and a user interface for communicating emergency call information with a caller. The control unit includes an emergency call processor for controlling emergency calls with a satellite and includes a location processor for determining the location of the personal communications device whereby an emergency call transmitted to the satellite includes the location of the personal communications device.

In one embodiment, the satellite communications system includes a satellite gateway for receiving a down-link emergency call transmitted from the satellite in response to an emergency call from a personal communications device, the down-link emergency call including the location of the personal communications device transmitting the emergency call to the satellite, the satellite gateway processing the down-link emergency call to request emergency services for dispatch to the location of the personal communications device.

In one embodiment, the down-link emergency call includes the location of the personal communications device transmitting the emergency call to the satellite and wherein the satellite gateway includes a PSAP index addressed by the location whereby a suitable PSAP is requested to dispatch emergency services to the personal communications device.

The foregoing and other objects, features and advantages of the invention will be apparent from the following detailed description in conjunction with the drawings.

### BRIEF DESCRIPTION OF THE DRAWINGS

FIG. 1 depicts a schematic representation of a personal communications device, including an emergency call processor, in a satellite system.

FIG. 2 depicts an emergency call processor used in the personal communication device in FIG. 1.

FIG. 3 depicts a location processor that forms part of the emergency call processor of FIG. 2.

FIG. 4 depicts a schematic representation of personal communications device of the FIG. 1 type deployed within communications range of multiple communications systems.

FIG. 5 depicts a schematic representation of a personal communications device formed as a combination of a smart phone and a satellite device.

FIG. 6 depicts a schematic representation of a personal communications device of the FIG. 5 formed as a combination of a smart phone and a satellite device which together implement an emergency call processor.

FIG. 7 depicts a schematic representation of the personal communications device including a cross router and including an emergency call processor.

FIG. 8 depicts a simplified block diagram of the personal communication device of the FIG. 7 type.

FIG. 9 depicts a schematic representation of a top view of one embodiment of the personal communications device of FIG. 6.

FIG. 10 depicts a schematic representation of an end view of the personal communications device of FIG. 6.

FIG. 11 depicts a schematic representation of personal communications device of FIG. 9 where the smart phone and a satellite device are nested together with the antenna flap open.

FIG. 12 depicts a schematic representation of an end view of the personal communications device of FIG. 11.

FIG. 13 depicts a schematic representation of personal communications device of FIG. 11 where the smart phone and a satellite device are nested together with the antenna flap closed.

FIG. 14 depicts a schematic representation of an end view of the personal communications device of FIG. 10.

FIG. 15 depicts a schematic representation of an end view of the personal communications device of FIG. 11 depicting by dotted lines the antenna rotated at different angles.

FIG. 16 depicts a schematic representation of a personal communications device formed as a combination of a smart phone and a satellite device.

FIG. 17 depicts a schematic block diagram representation of further details of the personal communications device of FIG. 16.

FIG. 21 depicts a schematic representation of another embodiment of the satellite device for use in the personal communications devices of FIG. 17.

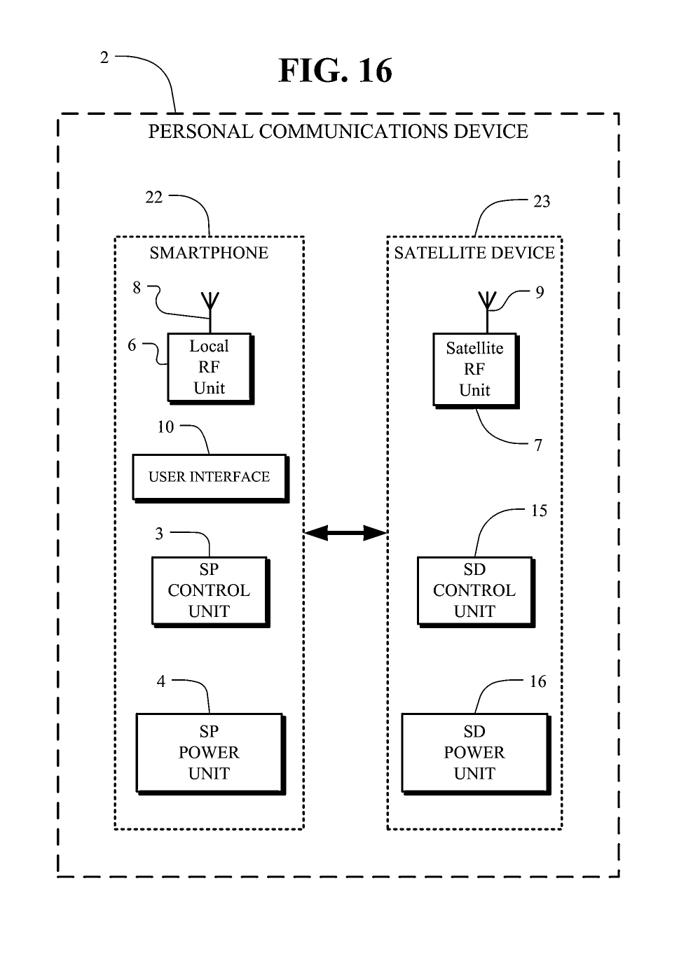

FIG. 19 depicts a schematic representation of another embodiment of a personal communications device of FIG. 16 where the local RF unit and the satellite RF unit are under common control in the same device.

FIG. 20 depicts a schematic representation of personal communications devices deployed within communications range of multiple communications systems including terrestrial local communications systems, a PSTN system and multiple satellite communications systems.

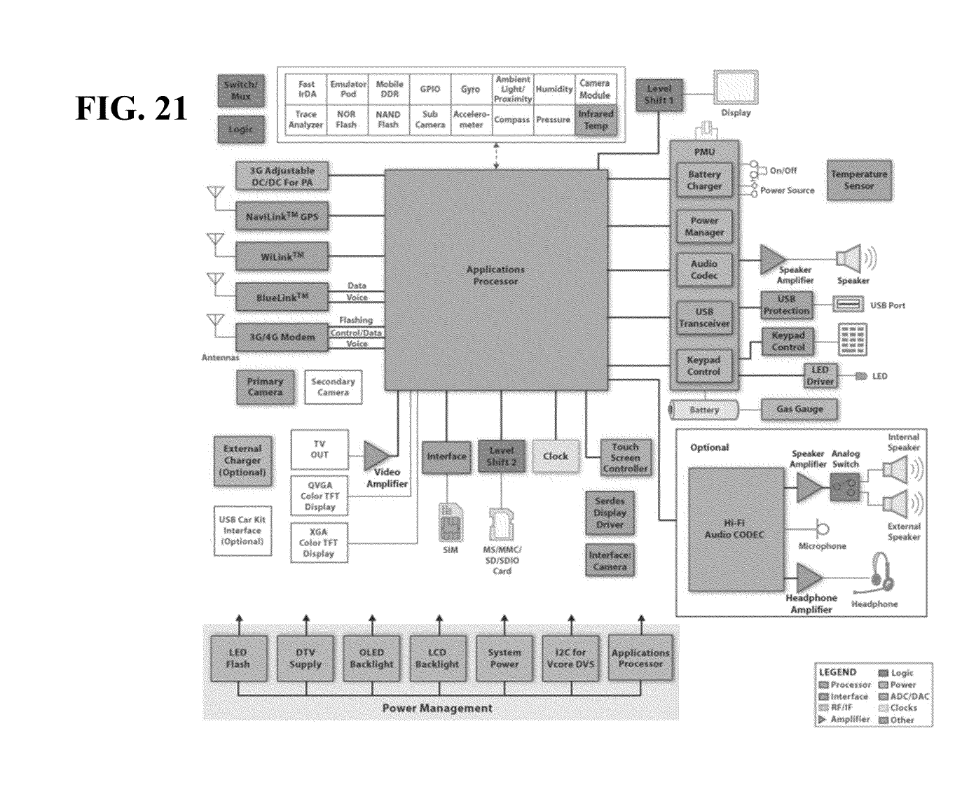

FIG. 21 depicts a detailed block diagram of a conventional smartphone.

### DETAILED DESCRIPTION

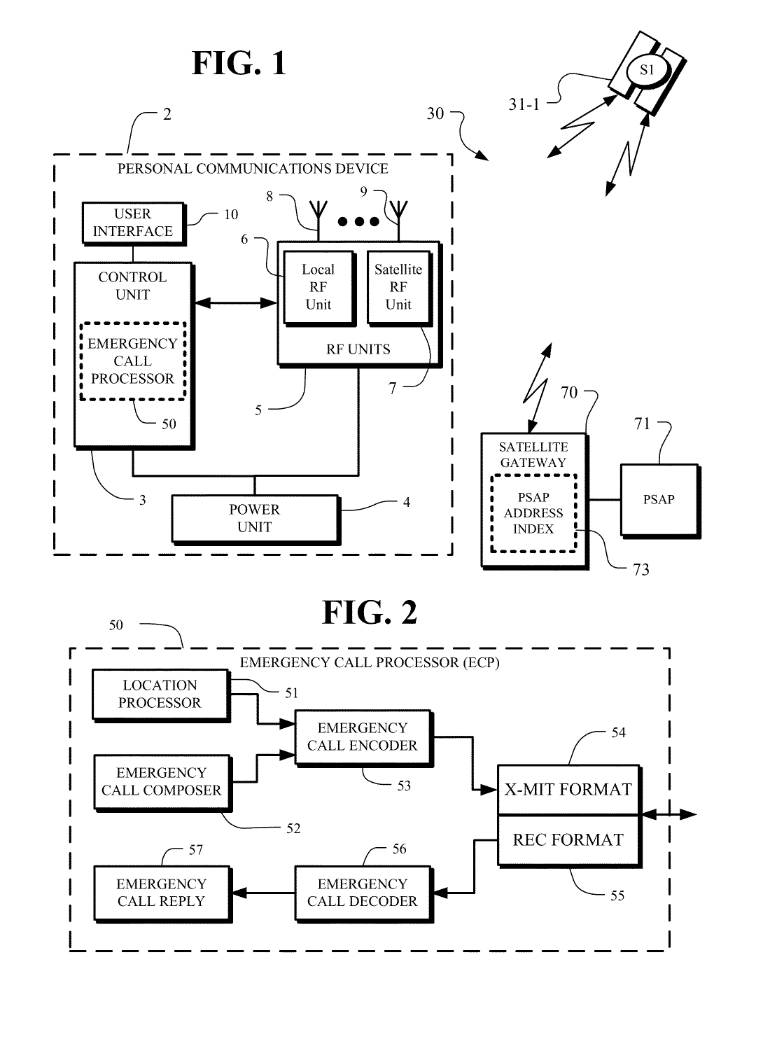

In FIG. 1, a schematic representation of a personal communications device 2 is shown including a control unit 3, a power unit 4 and a transceiver 5. The control unit 3 controls the communications of the personal communications device 2 and has the capacity to execute many different algorithms both hidden from user control and/or under user control. The control unit 3 includes an emergency call processor 50 for controlling emergency calls. The power unit 4 includes one or more batteries to enable the personal communications device 2 to be portable. The transceiver 5 includes the components for communications in multiple communications systems. The multiple communications systems include local communications systems and include satellite communications systems. Typical local communications systems are cellular systems.

For local communications, the personal communications device 2 typically includes all the features of a smartphone and is thereby able to communicate in local environments using a cellular communications system. Examples of such smartphones are Apple's i-phone using the Apple operating system and Samsung's Galaxy using the Android operating system. Many other smartphones are available or are becoming available using the Apple, Android, Windows or other operating systems.

In FIG. 1, a satellite 31-1 is part of a satellite communications system 30. In the system 30, the satellite 31-1 communicates with the personal communications device 2 and specifically communicates with the emergency call processor 50 for communicating emergency calls. The satellite 31-1 also communicates with the satellite gateway 70 which is typically a terrestrial station for relaying satellite ground communications including communications with a Public Service Access Point (PSAP) 71. The satellite gateway 70 includes a PSAP address index 73 for locating the appropriate PSAP 71. The address index 73 is a look-up table or other store which determines the closest appropriate PSAP to the location of the personal communication device 2 placing the emergency call.

Some of the satellite communications systems suitable for communications with the personal communications device 2 are listed in the following TABLE 1:

TABLE 1

| TYPE | Provider |
|---|---|
| LEO | Cospas-Sarsat |
| LEO | Iridium |
| LEO | Globalstar |
| LEO | Orbcomm |
| GEO | Inmarsat |

In FIG. 2, an emergency call processor 50 as used in the personal communication device 2 in FIG. 1 is shown. The emergency call processor 50 includes a location processor 50 for determining the location of the personal communications device 2 and an emergency call composer for composing the content of the emergency call. The emergency call content is for example a text message typed or orally input to as the personal communication device or is an automated message pre-stored in the personal communication device 2. For example, the typed text message could be “HELP NEEDED, BROKEN LEG AND CANNOT MOVE, NO BLEEDING”. In some embodiments, the personal communication device includes an interactive query where the personal communication device 2 presents a series of questions to the caller regarding the emergency and the caller responds with answers as part of the emergency call composition. The call query in one example is shown in the following TABLE 2:

TABLE 2

| QUESTION | ANSWER |
|---|---|
| IS YOUR LIFE IN DANGER? | NO |
| DO YOU HAVE INJURY TO BODY? | YES |
| ARE YOU BLEEDING? | YES |
| DO YOU HAVE BROKEN BONES? | YES |
| * | |
| * | |
| * | |

In FIG. 2, the emergency call encoder 53 encodes the location information from the location processor 51 and the composed emergency call from emergency call composer 52. In one embodiment, the emergency call and location information is generated as ASCII code and the emergency call encoder 53 encodes the emergency call as TTY baudot code in the form of tones for transmission over a voice channel. If necessary, the X-MIT formatter 54 formats the encoded emergency message in a format suitable for satellite transmission. In the example of TTY coding, the formatting is for a satellite voice channel.

In FIG. 2, the emergency call processor receives any response to an emergency call in the REC formatter 55 that recognizes the format of the received emergency call response message. The emergency call decoder 56 decodes the received emergency call response. If the emergency call response is a TTY baudot code, emergency call decoder 56 converts, if necessary, the TTY code to an ANSCII code for presentation of the emergency call reply to the caller. The message can be displayed on a user screen or orally over speakers in the personal communication device 2.

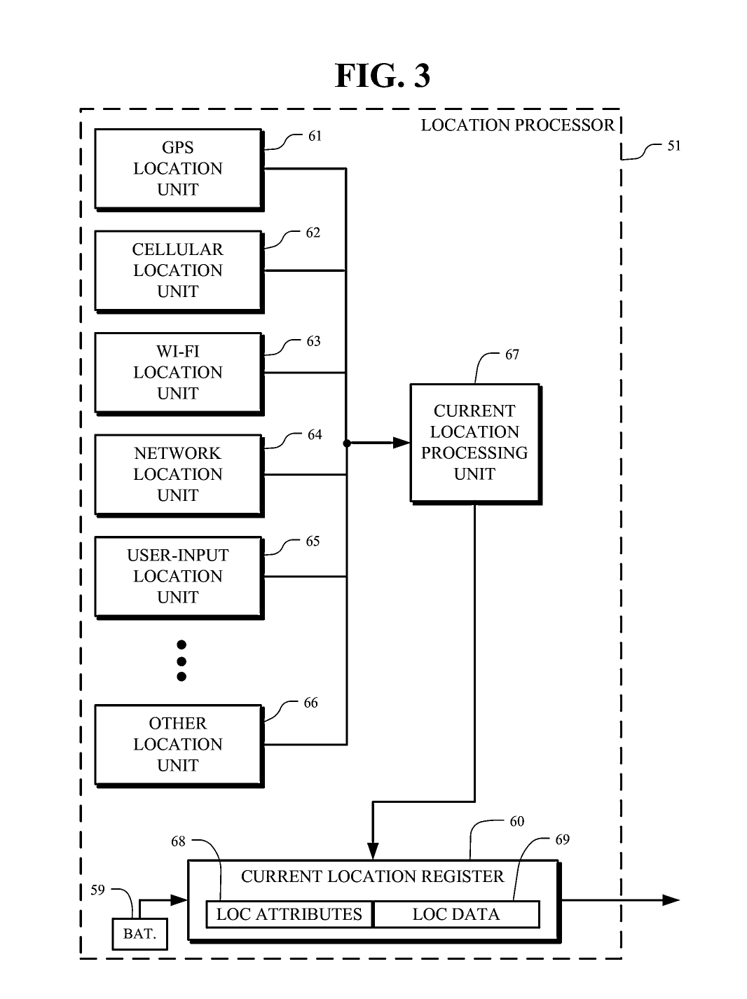

In FIG. 3 the location processor 51 used in the emergency call processor 50 of FIG. 2 is shown. The location processor 51 determines the location of the personal communications device 2 of FIG. 1 whereby an emergency call transmitted to the satellite 31-1 of FIG. 1 includes the location of the personal communications device 2. The location information determined by location processor 51 derives from one or more sources. Those sources include a GPS unit 61, a cellular location unit 62, a WI-FI location unit 63, a network location unit 64, a user-input location unit 65 and one or more other location units 66.

The GPS unit 61 in some embodiments executes the complex calculations based on signals collected from four orbiting satellites and these calculations can take as long as 12 minutes. In other embodiments, assisted GPS (A-GPS) is employed when a cellular or other network is available and the cellular or other network provides an approximate location to simplify and shorten the GPS calculations.

The cellular location unit 64 receives location information from the cellular system. The cellular system determines location using cell towers at base stations having fixed and known locations. By measuring the relative strength of a personal communications devices' signals, the distances that the personal communications devices are from the cell towers are roughly known. For a first tower, a device is known to be at a first radius from the first cell tower. For a second tower, the device is known to be at a second radius from the second cell tower. For the two radii from the first and second towers, the device is determined to be at one of two locations, that is, is determined to be at the two locations where the first and second radii intersect. For a third tower, the device is known to be at a third radius from the third cell tower. With three towers, the device is determined to be at a single location where the three radii intersect with an accuracy of about a few hundred meters. The speed at which the cellular system determines location using inputs from three towers is generally within a few seconds.

The Wi-Fi location unit 63 in some embodiments uses location services provided by operating systems of smart phone providers. The Location Services for Android, Apple, Windows and other operating systems on smart phones are periodically used to identify a personal communication device's location using available location techniques including GPS, Cell-ID, and Wi-Fi. A Location Service using Wi-Fi periodically sends out queries to personal communication devices. When queried, a personal communication device sends back information available to the personal communication device including publicly broadcast Wi-Fi access points detected and Service Set Identifier (SSID) and Media Access Control (MAC) data. These queries are made whether or not the personal communication device is using location-based applications such as Android's Google Maps and Latitude or using any other location-based applications with any operating system. The Location Service builds a map of locations based on the information collected.

The network location unit 64 in some embodiments requests the mobile network to calculate the personal communication device's location and to send back the exact location to the personal communications device.

The user-input location unit 65 operates in response to the user of the personal communications device entering location information through the user interface. In one embodiment, a user has a Wi-Fi internet connection at a home address, has a Wi-Fi internet connection at an office address and still additional Wi-Fi internet connections at locations frequented by the user. The user enters or confirms the addresses of these Wi-Fi locations so that whenever one of these Wi-Fi internet connections is recognized by the personal communications device, the location of the personal communications device is known by the address entered by the user or by the system.

The location units 61 through 65 are examples and not intended to be exhaustive. Any number of additional location units is possible as represented by other location unit 66.

In FIG. 3, the current location unit 67 operates to evaluate locations determined by any one or more or all of the location units 61 through 66 to determine the current location of the personal communications device and store that location in the location data field 69 of the current location register 60. In some embodiments, the current location unit 67 additionally determines attributes about the location and stores those attributes in the Location Attribute field 68 of the current location register 60.

The location attributes include one or more of the date and time the current location was last determined, the location unit or units used to determine the current address, the expected accuracy of the current address and other information.

The environments encountered by personal communications devices vary widely. When outside buildings, cellular communications are good in many populated areas of the world. In buildings, cellular communications are often weak and unreliable. In remote locations, cellular communications are often weak or unavailable. Satellite communications outside buildings are good at most locations of the world. Inside buildings, satellite communications tend to be weaker and hence unreliable in many locations.

Inside buildings and close to buildings, Wi-Fi and other local communications are reliable when they are present. However, local communications do not necessarily have location information without additional assistance. In general, there is no relationship between the network addresses used by callers and physical locations of the callers.

The current location unit 67 operates to select the best current location and the location attributes to be stored in register 60. A number of components are used in the algorithm used by the current location unit 67. An active component determines which ones of the locations units 61 through 66 are active units providing an active candidate for the current address. Among the active units, a priority component determines the order of priority of the active candidates. Usually, an active GPS location unit candidate address has the highest accuracy and the highest priority for outdoor locations. An active cellular unit candidate address may have the next highest priority for outdoor locations. A comparison component compares the candidate addresses. If the higher priority candidate addresses are the same, then that same address is stored in the current location register.

Under some circumstances, a Wi-Fi location unit candidate address may have higher priority. If a Wi-Fi candidate address has been identified by a user as a home address, an office address or other known frequented address, then when the personal communication device detects the presence of such Wi-Fi signals, then the corresponding candidate addresses have high priority, particularly if they are the same as the most recent GPS location unit candidate address or the cellular unit candidate address.

Under some circumstances, other ones of the location units 61 through 66 candidate addresses have high priority. In one example, a personal computer device is transported by a user from an outdoor location with a good GPS and/or cellular candidate location address to an indoor location where GPS and/or cellular location candidate location addresses are not reliable. In such an example, if Wi-Fi or other known candidate addresses are known at the indoor location, then such known candidate addresses are reliable and are used to update the current location register 60.

Under some circumstances, a user may move from a location, such as outdoors, with good GPS and/or cellular candidate locations to a location, such as indoors, where the GPS and cellular service is lost and where the user has not entered any Wi-Fi or other candidate location addresses. Notwithstanding the absence of a prior user input of location addresses, if the current location unit 67 detects that Wi-Fi or other local signals are present at the time just before or shortly after a service such as GPS is lost, the location unit 67 assigns the last good GPS candidate location address as the candidate location address for the detected Wi-Fi or other local signals. The assignment is good even if the user does not have access to the codes, if necessary, needed to use the Wi-Fi or other local signal services. As long as the personal communications device is receiving the Wi-Fi or other local signal, the candidate location address assigned remains valid.

At times when a personal communications device is relying on a Wi-Fi candidate location address and no other candidate location address is available, the Wi-Fi service may be turned off or otherwise lost so as to decrease the reliability of the address in the current location register 60. In such circumstances and in some embodiments, the current location unit 67 queries the user through the user interface 10 of FIG. 1 to determine if the user can validate the address in the register 60.

At times a user may turn the personal communications device power off. In some embodiments, the information in current address register 60 is maintained through a dedicated backup battery 39 (in FIG. 3) or other power-off storage means even when the personal communications device is turned off.

When power for the personal communications device is again turned on, the address in the current location register is revalidated by the current location unit 67 using inputs from any or all of the location units 61 through 66. In some circumstances, the current location unit 67 queries the user through the user interface 10 of FIG. 1 to determine if the user can validate the address in the register 60.

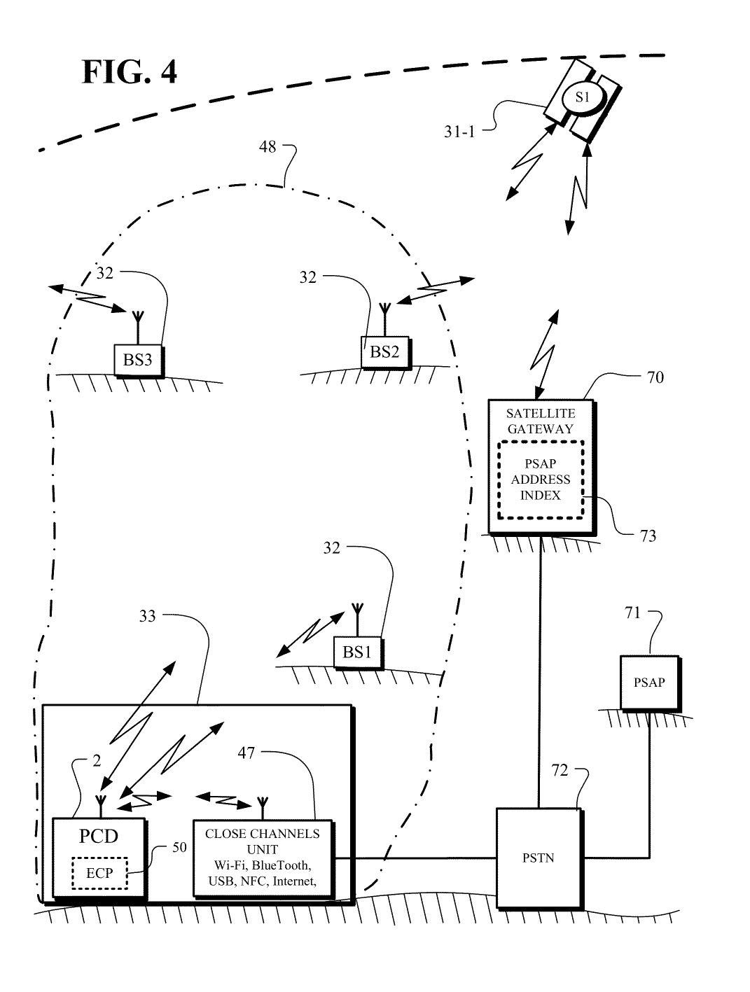

In FIG. 4, a schematic representation is shown of a personal communications device 2 deployed within communications ranges of terrestrial close communications systems 47, cellular communications systems within a cellular region 48 and satellite communications systems including satellite 31-1. The satellite 31-1 is typically part of a satellite constellation including a number of satellites. Such satellites in a constellation have shared controls to provide coordinated ground coverage for satellite communications with the personal communications device 2 and other ground based devices. The satellites in a communications system includes a geosynchronous satellite (GEO) 31-1 or any satellite such as those identified in the foregoing TABLE 1.

In FIG. 4, communications to personal communications device 2 are provided by a number of services. Cellular communications is provided to personal communications device 2 by the cellular system which includes the base stations 32 (BS1, BS2 and BS3) in the cellular region 48. Although the personal communications device 2 can have cellular service anywhere in the cellular region 48, the presence of hills, buildings and other outdoor features may block cellular service. Also cellular service may be lost indoors such as in building 33.

In FIG. 4, satellite services are provided to personal communications device 2 anywhere in the region of FIG. 4 except that hills, buildings and other outdoor features may block satellite service. Also satellite service may be lost indoors such as in building 33. The satellite system also includes a satellite gateway 70 which is typically a terrestrial station for relaying ground communications. The satellite 31-1 communicates with the personal communications device 2 for communications including emergency calls. The satellite 31-1 communicates through satellite gateway 70 with a Public Service Access Point (PSAP) 71. The satellite gateway 70 includes a PSAP address index 73 for locating the appropriate PSAP 71. The address index 73 is a look-up table or other store which determines the closest appropriate PSAP to the location of the personal communication device 2. Typically, the satellite gateway 70 communicates with the PSAP through the PSTN 72.

In the building 33, a number of wired and wireless channels in close channels unit 47 are available. One or more of the wireless services including Wi-Fi, Bluetooth and NFC are available to communicate personal communications device 2. Also, USB ports, internet connections and PSTN connections are available through wired or wireless connections. In one example, the personal communications device 2 has a Wi-Fi connection to the close channels unit 47 which in turn has an internet connection over the PSTN. The Wi-Fi and internet connections can be used for data and VoIP communications by the personal communications device 2. When the personal communications device 2 is indoors and has poor or no direct satellite service or cellular service, calls from the emergency call processor 50 can be sent via Wi-Fi and internet connections using VoIP or other protocols.

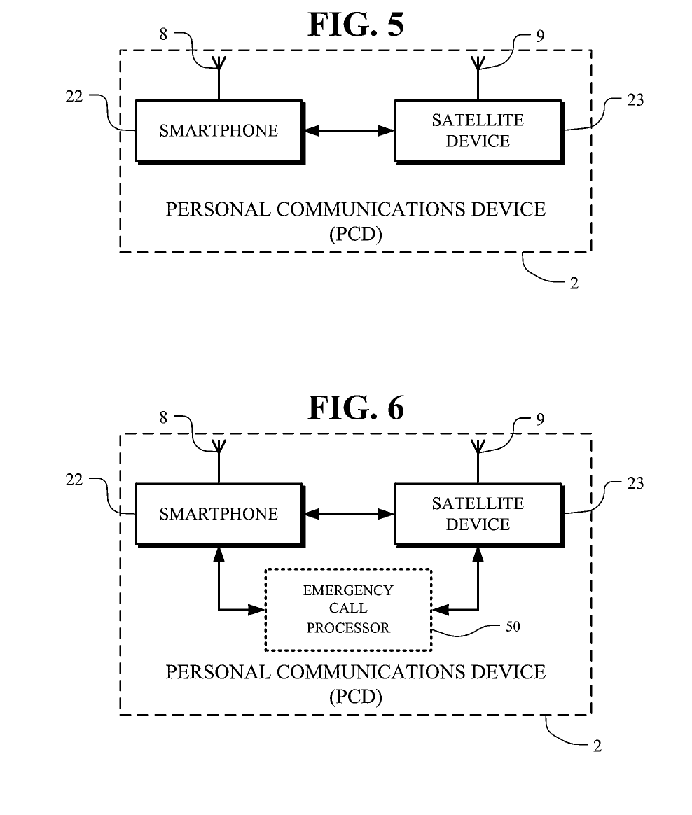

In FIG. 5, a schematic representation of a personal communications device 2 formed as a combination of a smartphone 22 and a satellite device 23 is shown. The combination of the smartphone 22 and the satellite device 23 inherently includes the control unit 3, the power unit 4 and the transceiver 5 as described in connection with FIG. 1. These units 3, 4 and 5 can be either distributed or integrated. In a fully distributed embodiment, the smartphone 22 is essentially a standalone device like Apple's i-phone, Samsung's Galaxy or other available smartphones. These smartphones operate in standard cellular systems. In the fully distributed embodiment, the satellite device 23 is an add-on to the smartphone 22 using, where possible, components and operations of the smartphone 22 while providing the additional components and operations necessary for satellite communications. Among other things, the additional components for satellite operation include an antenna 9 and transceiver circuits suitable for satellite communications. The control unit 3 and power unit 4 components of the smartphone 22 can be shared, or shared in part, with the satellite device 23.

In FIG. 6, a schematic representation is shown of the personal communications device 2 of the FIG. 5 formed as a combination of the smart phone 22 and the satellite device 23 which together implement an emergency call processor 50. Those functions of the emergency call processor 50 which are performable by the smart phone 22 are included within the smart phone 22 and those functions which are not are included in the satellite device 23.

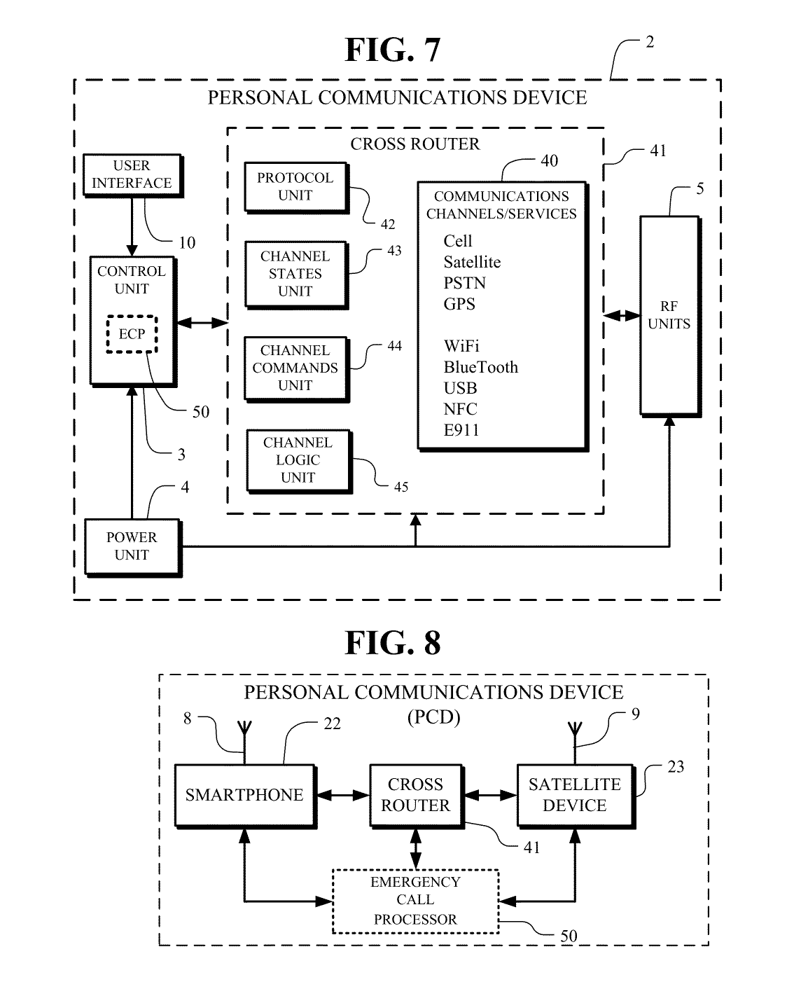

In FIG. 7, a schematic representation of a personal communications device 2 is shown including a cross router 41 and including an emergency call processor 50. The personal communications device 2 also includes a control unit 3, a power unit 4, a user interface 10 and RF units 5. The control unit 3 controls the communications of the personal communications device 2 and has the capacity to execute many different algorithms both hidden from user control and/or under user control. The emergency call processor 50 typically is as shown and described in connection with FIG. 2. The power unit 4 includes one or more batteries to enable the personal communications device 2 to be portable. The personal communications device 2 includes components for communications over multiple communication channels in multiple communications systems. The multiple communications systems include close communications systems, cellular communication systems and satellite communications systems. Typical close communications systems are Wi-Fi, BlueTooth, NFC, VoIP, PSTN and other systems and can include USB wired or other ports.

In FIG. 8, a simplified block diagram of the personal communication device 2 of the FIG. 10 type is shown. The personal communications device 2 is formed as a combination of the smart phone 22, a cross router 41 and the satellite device 23 which together implement an emergency call processor 50. Those functions of the emergency call processor 50 which are performable by the smart phone 22 are included within the smart phone 22 are either in the cross router 41 or in the satellite device 23.

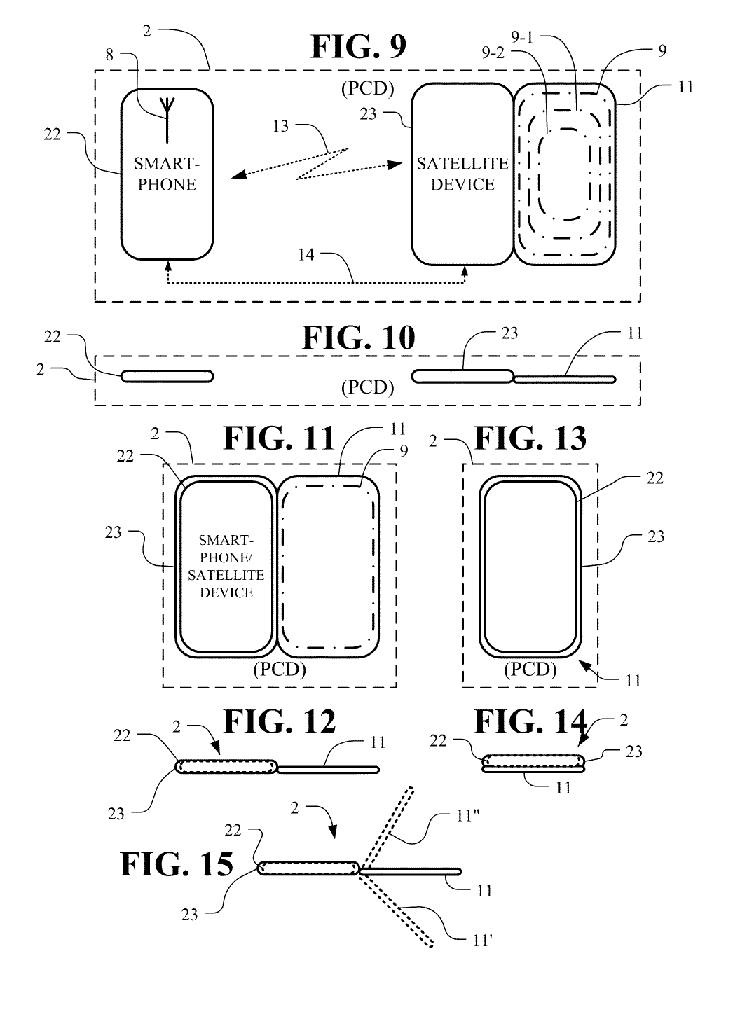

In FIG. 9, a schematic representation of a top view of one embodiment of the personal communications device 2 of FIG. 1 is shown. In FIG. 9, the approximate sizes of the smartphone 22 and the satellite device 23 of FIG. 2 are shown. In FIG. 9, the personal communications device 2 is a fully distributed embodiment where the smartphone 22 is essentially a standalone device like Apple's i-phone, Samsung's Galaxy or other readily available smartphones. In this fully distributed embodiment, the smartphone 22 communicates with the satellite device 23 with an RF link 13 (such as Bluetooth, Wi-Fi or other) through the Bluetooth, Wi-Fi or other facilities of the smartphone 22 and satellite device 23 or by a direct wire connection 14 through the wire plug connections of the smartphone 22 and satellite device 23. The satellite device 23 includes an area, such as flap 11, that contains the satellite antenna 9. The flap 11 in some embodiments includes multiple antennas 9, 9-1, 9-2 and so on having sizes and properties suitable for different ones of the satellite frequencies of satellite communications systems.

In FIG. 10, a schematic representation of an end view of the personal communications device 2 of FIG. 9 is shown. The smartphone 22 and the satellite device 23 are represented for purposes of illustration as separated by a distance. The distance in actuality may be of any amount from nothing to numbers of meters depending upon the embodiment selected. The distance, however, cannot exceed the communication range of the RF connection 13 or the wired connection 14.

In FIG. 11, a schematic representation of personal communications device 2 of FIG. 9 is shown where the smartphone 22 and the satellite device 23 are superimposed and nested together without any separation. The flap 11 holding the satellite antenna 9 is shown in the fully open position.

In FIG. 12, a schematic representation of an end view of the personal communications device 2 of FIG. 8 is shown where the smartphone 22 and the satellite device 23 are superimposed and nested together without any separation. The flap 11 is shown in the fully open position.

In FIG. 13, a schematic representation of personal communications device 2 of FIG. 11 is shown where the smart phone 22 and the satellite device 23 are nested together with the antenna flap 11 closed and under the superimposed smart phone 22 and satellite device 23.

In FIG. 14, a schematic representation of an end view of the personal communications device 2 of FIG. 13 is shown. The smart phone 22 and the satellite device 23 are nested together with the antenna flap 11 closed and under the superimposed smart phone 22 and satellite device 23.

In FIG. 15, a schematic representation of an end view of the personal communications device 2 of FIG. 11 is shown. The flap 11 is in a fully open position and can be rotated as depicted by dotted lines. The flap 11 is rotated in one direction to the position shown as 11′ and is rotated in the opposite direction to the position shown as 11″. The rotation of the flap 11 and therefore the antenna 9 assists in the good communication between the personal communications device 2 and a satellite 31.

In FIG. 16, a schematic representation of a personal communications device 2 formed as a combination of a smart phone 22 and a satellite device 23 is shown. The smartphone 22 includes a local RF unit 6, a user interface 10, a SP control unit 3 and an SP power unit 4. The local RF unit 6 operates to communicate with local communication systems such as cellular systems. The user interface 10 operates with inputs from and outputs to a user. For example, the inputs include keypad and audio inputs and the outputs include display and audio outputs. The SP control unit 3 includes a processor, storage and related devices for controlling operations of the smartphone 22 and the personal communications device 2. The SP control unit 3 executes code including algorithms useful or necessary for control operations. The SP power unit 4 includes a battery and other components for powering the smartphone 22 and the personal communications device 2.

The satellite device 23 includes a satellite RF unit 7, a SD control unit 15 and an SD power unit 15. The satellite RF unit 7 operates to communicate with satellite communication systems such as LEO and GEO systems. The satellite device 23 operates for user interface operations under control of the user interface 10 of smartphone 22. In alternate embodiments, satellite device 23 can include a user interface. The SD control unit 15 includes a processor, storage and related devices for controlling operations of the satellite device 23 and the personal communications device 2. The SD control unit 15 executes code including algorithms useful or necessary for control operations. The SD power unit 16 includes a battery and other components for powering the satellite device 23 and the personal communications device 2.

In FIG. 14, a schematic block diagram representation of further details of the FIG. 16 personal communications device 2 is shown.

In FIG. 15, the smartphone 22 includes RF units 5′, a user interface 10, a SP control unit 3 and an SP power unit 4. The RF units 5′ includes a GPS unit 5′-1, a Wi-Fi unit 5′-2, a Bluetooth unit 5′-3 and a local RF unit 6. The local RF unit 6 operates to communicate with local communication systems such as cellular systems. The user interface 10 includes a display/touch screen 10-1, a camera 10-2 and a speaker/microphone 10-3 and operates with inputs from and outputs to a user. For example, the inputs include keypad and audio inputs and the outputs include display and audio outputs. The SP control unit 3 includes a processor, storage and related devices for controlling operations of the smartphone 22 and the personal communications device 2. The SP control unit 3 executes code including algorithms useful or necessary for control operations. The SP power unit 4 includes a power management unit 4-1 and a battery 4-2 for powering the smartphone 22 and the personal communications device 2.

In FIG. 15, satellite device 23 includes RF units 5″, an SD control unit 15 and an SD power unit 16. The RF units 5″ include at least a satellite RF unit 7. The satellite RF unit 7 operates to communicate with satellite communication systems such as LEO and GEO systems. The SD control unit 15 includes a processor 15-1, a USB port 15-2, a clock 15-3 and storage including memory 15-4. The SD control unit 15 operates to control operations of the satellite device 23 and the personal communications device 2. The SD control unit 15 executes code, stored in memory 15-4, for performing algorithms useful or necessary for control operations. The SD power unit 16 includes an SD power management unit (PMU) 16-1, a battery 16-2 and super capacitors 16-3 for powering the satellite device 23 and the personal communications device 2. The satellite device 23 connects through connector 18 to the connector 17 of the smartphone 22. In one embodiment, the connector 18 is connected to a terminal 19 which provides the ability to recharge the battery 16-2 and capacitors 16-3 in the satellite device 23 and the battery 4 in the smartphone 22.

In FIG. 19, a schematic representation is shown of another embodiment of a satellite device 23 for use in the personal communications device 2 of FIG. 18. The satellite device 23 includes RF units 5″, an SD control unit 15 and an SD power unit 16. The RF units 5″ include a Wi-Fi unit 5″-2, a Bluetooth unit 5″-3 and a satellite RF unit 7. The satellite RF unit 7 operates to communicate with satellite communication systems such as LEO and GEO systems. The Wi-Fi unit 5″-2 and a Bluetooth unit 5″-3 are available for communicating with the Wi-Fi unit 5′-2 and Bluetooth unit 5′-3 of the smartphone 22 of FIG. 15. The interaction between the smartphone 22 and the satellite device 23 is controlled by the Bluetooth and/or Wi-Fi RF connections. The SD control unit 15 includes a processor 15-1, a clock 15-3 and storage including memory 15-4. The SD control unit 15 operates to control operations of the satellite device 23 and the personal communications device 2. The SD control unit 15 executes code, including algorithms useful or necessary for control operations, stored in memory 15-4. The SD power unit 16 includes an SD power management unit (PMU) 16-1 and a battery 16-2 for powering the satellite device 23 and the personal communications device 2.

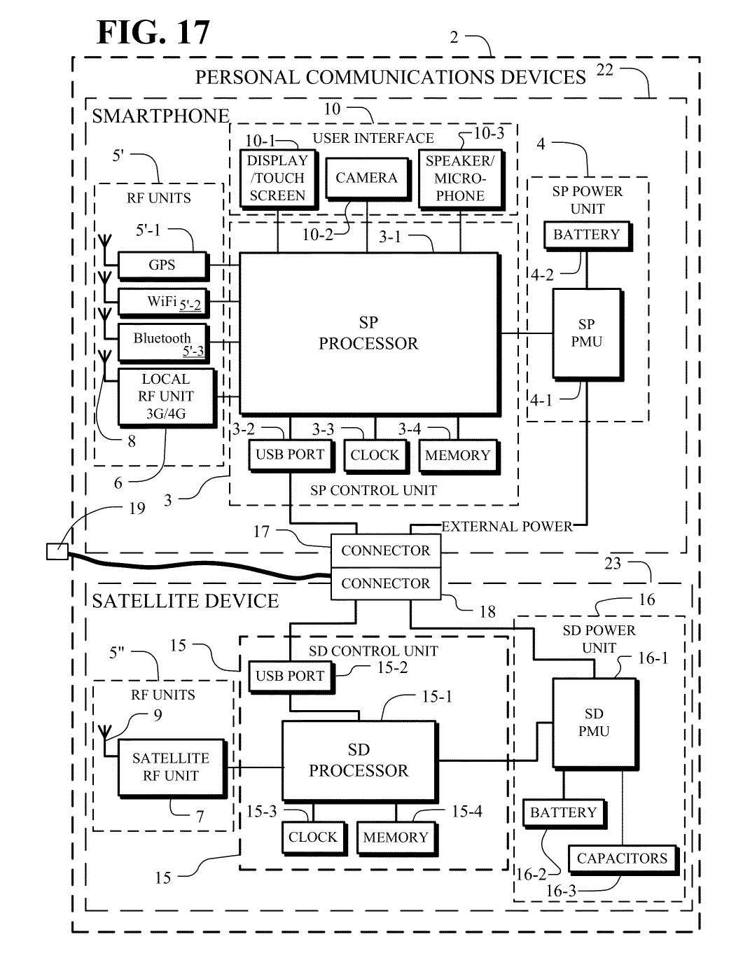

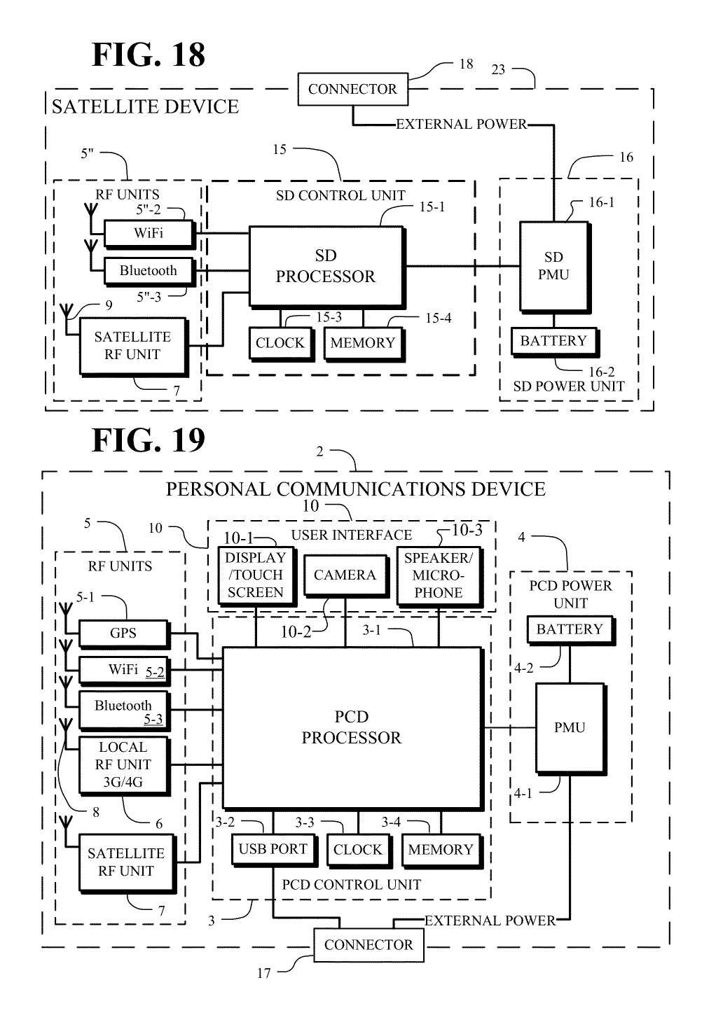

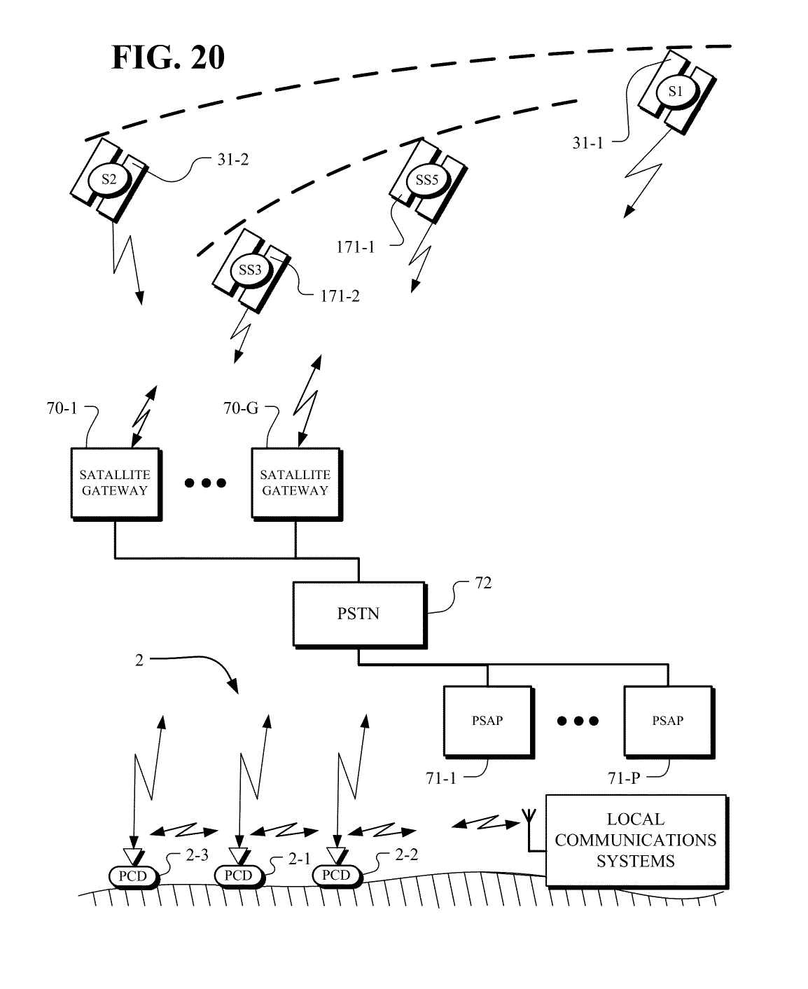

In FIG. 19, a schematic representation is shown of another embodiment of a personal communications device 2 of FIG. 1 where the local RF unit 6 and the satellite RF unit 7 are under common control of the PCD control unit 3. In FIG. 17, the personal communications device 2 includes RF units 5, a user interface 10, a PCD control unit 3 and a PCD power unit 4. The RF units 5 include a GPS unit 5-1, a Wi-Fi unit 5-2, a Bluetooth unit 5-3 and a local RF unit 6. The local RF unit 6 operates to communicate with local communication systems such as cellular systems. The user interface 10 includes a display/touch screen 10-1, a camera 10-2 and a speaker/microphone 10-3 and operates with inputs from and outputs to a user. For example, the inputs include keypad and audio inputs and the outputs include display and audio outputs. The PCD control unit 3 includes a processor, storage and related devices for controlling operations of the personal communications device 2. The PCD control unit 3 executes code including algorithms useful or necessary for control operations. The PCD power unit 4 includes a power management unit 4-1 and a battery 4-2 for powering the smartphone 22 and the personal communications device 2.

In FIG. 20, a schematic representation is shown of personal communications devices 2 of the FIG. 1 type deployed within communications range of multiple communications systems. The communications systems of FIG. 20 include local communications systems 80. In one embodiment, the local communications systems 80 is a cellular system. In the cellular system, the personal communications devices 2, including devices 2-1, 2-2 and 2-3, communicate in small geographic areas called cells. Each cell covers a small geographic area and collectively an array of adjacent cells covers a larger geographic region. The local communications systems 80 includes Base Station (BS) which handle all the cellular calls for the personal communications devices 2.

The communications systems of FIG. 20 in some embodiments includes local communications systems for emergency, search and rescue such as Civil Air Patrol, Marine, Mountain Rescue, Fire and Police. The air patrol communicates from an aircraft 70 having a local RF transceiver 70. The communications systems of FIG. 18 in some embodiments includes one or more satellite communications systems. For example, the GEO satellites 31-1 and 31-2 are in a GEO orbit and the LEO satellites 71-1 and 71-2 are in a LEO orbit.

In FIG. 21, a detailed block diagram is shown of a conventional smartphone. The block diagram is published by Texas instruments at:
http://www.ti.com/solution/handset_smartphone#

The operation of personal communications devices 2 requires execution of code in the one or more processors such as the SP processor 3-1, the SD processor 15-1 of FIG. 15 or the PCD processor 3-1 of FIG. 17. The selection of which one or ones of the processors to employ for execution code is a matter of design choice. The following are examples of the functions to be carried out by execution of code in the personal communications devices 2 represented by the FIG. 15 embodiment.

Low Signal Code. Under normal high signal strength operation, the personal communications device 2 is operating in local cellular communications mode and the satellite communications is silent. When the received signal strength indicator (RSSI) in the smartphone 2 indicates that the cellular network communication strength is below a threshold, it suggests that sending or receiving a message via the local cellular network is not likely to get through. This low level signal strength indication is detected and initiates the Low Signal Code Algorithm (LSA).

In most cases, the LSA will immediately begin the satellite communications process. This process entails a) putting the local cellular communicator in the smartphone 22 in airplane mode, turning OFF the cellular radio in the smartphone 22; b) waking up the L band transverter in the satellite RF unit 7 of the satellite device 23; c) begin executing the transaction processing code for the transaction processing algorithm (TPA) and d) update the user screen in the smartphone 22 providing the user with new options that come with the satellite communications application. Examples of options include Google SMS search, email indexing and Mayday call-out.

The LSA does not begin the satellite process when the RSSI signal strength indicator is intermittently adequate. In such cases, test code using hysteresis of the RSSI signal strength indicator will evaluate the need to switch to satellite communications. As a result of the test, a decision to switch to satellite mode is made. Similarly, if the RSSI signal strength indicator test indicates that cellular communications can be performed while the communications is in satellite mode, a decision will be made whether to switch to cellular mode.

Low Energy Code. When the smartphone 22 has a low battery level, the energy monitoring code will initiate the Low Energy Algorithm. The energy monitoring code will check the RSSI indicator to evaluate the cellular communications signal strength. If the cellular communications signal strength is also low, a message is displayed on the display/touch screen 10-1 of smartphone 22 indicating that the smartphone 22 will be placed in Airplane Mode to conserve energy. This operation allows the smartphone 22 to retain adequate energy to complete a satellite message when needed.

Mayday Emergency Code. In order to respond to a significant emergency, a special input is provided to override and take priority over all other functions. The special input in one embodiment is a “Mayday Button” touch screen button displayed on the display/touch screen 10-1 of the smartphone 22. Alternatively, the satellite device 23 includes a physical button (not shown) that provides a “Mayday Signal” to activate the Mayday Code. Upon activation, the mayday code will execute the Mayday Processor Algorithm (MPA). In such case, the MPA will a) get a GPS fix on the location of the personal communications device 2, b) evaluate all communications paths to find out which communications paths are feasible; c) calculate satellite positions of appropriate satellites; d) evaluate the nature of the emergency, for example, by posing a small number of questions (four to five) to the user; e) select and then activate all appropriate transmitters and receivers.

Battery Management Code. Battery management code performs a Battery Management Algorithm (BMA) which keeps track of energy spent and energy available. The BMA determines the energy required to communicate by cellular and by satellite. The BMA determines the current charge state of the batteries, battery 4-2 in the smartphone 4-2 and battery 16-2 in the satellite device 16-2. The BMA also manages the charging of the capacitors 16-3 (when needed) and the recharging of all batteries and capacitors. An external plug 19 is provided to power the personal communications devices 2 in emergency conditions.

Transaction Processing Code. When satellite messages are sent or received, charges for this service are applied. The reimbursement for these charges will be by credit or debit card. However, in most cases, the transaction information will be stored on the personal communications devices 2 and maintained until the next time that the personal communications devices 2 is within cellular range. Typically, the transaction costs and other data are not sent over the satellite channel. When the personal communications devices 2 is within cellular range, the accumulated transactions and charges are dumped to a processing center such as Paypal or Square which will complete payments and processing for the transactions.

While the invention has been particularly shown and described with reference to preferred embodiments thereof it will be understood by those skilled in the art that various changes in form and details may be made therein without departing from the scope of the invention.

1. A personal communications device for communications including emergency calls using a satellite in a satellite communications system comprising,
a power unit for powering the personal communications device,
a transceiver unit for communicating with the satellite,
a control unit for controlling the personal communications device, the control unit including an emergency call processor for controlling emergency calls with the satellite and including a location processor for determining the location of the personal communications device whereby an emergency call transmitted to the satellite includes the location of the personal communications device,
a user interface for communicating emergency call information with a caller.

2. The device of claim 1 wherein the emergency call processor generates the emergency call as text code.

3. The device of claim 1 wherein the emergency call processor generates the emergency call as TTY code.

4. The device of claim 1 wherein TTY code results from the conversion of text to baudot where baudot encodes the call as tones for transmission over a voice channel.

5. The device of claim 1 wherein the location processor selects the device location from one or more of GPS, Wi-Fi and Cellular location units.

6. The device of claim 1 including a current location register for storing the most current device location and wherein the location processor determines the most current device location for storing in the current location register.

7. The device of claim 6 wherein the location processor includes,
a plurality of location units, each for providing a candidate location for the current device location,
a current location processing unit for analyzing candidate locations from the location units to determine the current location stored in the current location register.

8. The device of claim 1 including a cross-router for selecting the communications services to be used by the device.

9. An emergency call system for processing emergency calls from personal communications devices comprising,
one or more satellites in a satellite communications system for processing emergency calls,
one or more personal communications devices, each personal communications device including,
a power unit for powering the personal communications device,
a transceiver unit for communicating with the satellite,
a control unit for controlling the personal communications device, the control unit including an emergency call processor for controlling emergency calls with a satellite and including a location processor for determining the location of the personal communications device whereby an emergency call transmitted to the satellite includes the location of the personal communications device,
a user interface for communicating emergency call information with a caller.

10. The system of claim 9 wherein the satellite communications system includes a satellite gateway for receiving a down-link emergency call transmitted from the satellite in response to an emergency call from a personal communications device, the down-link emergency call including the location of the personal communications device transmitting the emergency call to the satellite, the satellite gateway processing the down-link emergency call to request emergency services for dispatch to the location of the personal communications device.

11. The device of claim 10 wherein the down-link emergency call includes the location of the personal communications device transmitting the emergency call to the satellite and wherein the satellite gateway includes a PSAP index addressed by the location whereby a suitable PSAP is requested to dispatch emergency services to the personal communications device.
